(19) United States
(12) Patent Application Publication
(10) Pub. No.: US 2012/0236542 A1
(43) Pub. Date: Sep. 20, 2012

(54) FLEXIBLE LINE ASSEMBLY

(75) Inventor: WALDEMAR WARKENTIN, BAD OEYNHAUSEN (DE)

(73) Assignee: ANJA KOSCHORRECK, DOERENTRUP (DE)

(21) Appl. No.: 13/422,301

(22) Filed: Mar. 16, 2012

Related U.S. Application Data
(60) Provisional application No. 61/453,282, filed on Mar. 16, 2011.

(30) Foreign Application Priority Data
Mar. 16, 2011 (DE) DE 202011000603.4

(51) Int. Cl. F21V 21/08; F21L 4/00

(52) U.S. Cl. 362/103; 362/208

(57) ABSTRACT

A flexible line assembly is formed, in particular, as a strap or a leash of an animal guide device, a strap of a purse or a strap of an item of clothing. The line carries an electric consumer that is connectible to a voltage source which, in turn, is fastenable to the line. The line further carries a flashlight holder for releasably holding a flashlight with an integrated voltage source. The flashlight holder has electric contacts which are couplable to the voltage source of the flashlight, and the contacts are connected to the electric consumer.

### CROSS-REFERENCE TO RELATED APPLICATION

This application claims the benefit, under 35 U.S.C. §119(e) of provisional application No. 61/453,283, filed Mar. 16, 2011, and further claims the priority, under 35 U.S.C. §119(a), of German application DE 20 2011 000 603.4, filed Mar. 16, 2011 and; the prior applications are herewith incorporated by reference in its entirety.

### BACKGROUND OF THE INVENTION

### Field of the Invention

The present invention relates to a flexible line, in particular to a strap or a leash of an animal guide device, a strap of a purse or of an item of clothing. The line has at least one electric consumer which is connected to a voltage source that is fastenable to the line.

It is known from the prior art to provide such flexible lines, which are used, in particular, as a strap or a leash for an animal guide device, for example a dog leash, or also as part of a purse or of an item of clothing, with a luminant in order to make the user of the animal guide device, of the purse or of the item of clothing properly visible at night or where visibility is otherwise unsatisfactory. This is the case, in particular, in the context of highway traffic and the provision of lighting devices results in increased safety of the user.

The lines are usually provided with a voltage source, in particular with batteries or rechargeable batteries that serve to supply the luminant or luminaire.

It is a disadvantage of those lines and assemblies that the lighting of the lines only provides passive safety and to light up sources of danger in an active manner or when walking along paths in the dark, the user additionally has to take along a flashlight. A disadvantage is also that in the case of batteries or rechargeable batteries that are only poorly charged, the power of the rechargeable batteries is possibly reduced so severely during a walk in the dark that there is no longer any guarantee that the assembly will be lit. As a result, the passive safety of the person who is taking the line along, for example, as a dog leash or as part of a purse that they are carrying, is no longer ensured.

### SUMMARY OF THE INVENTION

It is accordingly an object of the invention to provide a flexible line assembly which overcomes the above-mentioned disadvantages of the heretofore-known devices and methods of this general type and which provides for a flexible line assembly where the permanent supply of power to the electric consumer that is attached on the line is ensured.

With the foregoing and other objects in view there is provided, in accordance with the invention, a flexible line assembly, such as a strap or a leash of an animal guide device, a strap of a purse, or a strap of an item of clothing. The flexible line assembly comprises:

a flexible line and at least one electric consumer disposed on or integrated in the flexible line;

a flashlight holder for releasably mounting a flashlight to the line, the flashlight holder carrying electrical contacts connected to the at least one electric consumer; and

a flashlight having an integrated voltage source, the flashlight and the flashlight holder being configured such that the at least one electric consumer is couplable to the voltage source of the flashlight when the flashlight is mounted to the flashlight holder.

In other words, the objects of the invention are achieved in that the flexible line has a flashlight holder for the releasable holding of a flashlight with an integrated voltage source, wherein the flashlight holder has electric contacts which are couplable to the voltage source of the flashlight and are connected to the at least one electric consumer.

This means that the flashlight which is fastened on the flexible line is used at the same time as a voltage source for the electric consumer which is arranged on the flexible line, which means that the user of the flexible line always also has a flashlight available.

In accordance with an added feature of the invention, the electric consumer is realized as a signal generator, in particular as a luminant or ultrasonic generator. In the case of the design variant as a luminant, the passive safety of the user is increased in that, with the flashlight fastened on the flexible line, the luminants which are attached to the flashlight light up, which means that the flexible line is easily visible to third parties even in the dark.

In accordance with an additional feature of the invention, the electric contacts of the flashlight holder are connected to an energy storage means which is fastened on the line, wherein the energy storage means is connected to at least one electric consumer. By attaching a further such energy storage means on the line, it is possible for the electric consumer which is attached on the line to be operated even when the flashlight has been removed. The energy storage means, in this case, is always charged when the flashlight is held in the flashlight holder of the line.

In accordance with a concomitant feature of the invention, the flashlight holder has a receiving web which can be slid into a groove in the housing of the flashlight. In particular, in this case, in an end face of the flashlight at which the groove terminates, there is provided a locking element which is displaceable transversely with respect to the sliding-on direction of the flashlight holder and which, in a closed position, fixes the receiving web in the groove and as a result prevents the flashlight unintentionally being released or falling off the flashlight holder.

Other features which are considered as characteristic for the invention are set forth in the appended claims.

Although the invention is illustrated and described herein as embodied in a flexible line, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1A is a schematic perspective illustration of a flexible line assembly, implemented as an animal guide device, with a flashlight fastened on the line;

FIG. 1B shows the flashlight detached from the line;

FIG. 2A and FIG. 2B are schematic representations of the flashlight holder and the flashlight to show the holder for the flashlight;

FIG. 3 is a partial perspective view of a detail of the flashlight with a locking element in an open position;

FIG. 4 is a similar view, with the locking element in a closed position;

FIG. 5 shows the end face of the flashlight shown in FIGS. 3 and 4 with the locking element not shown; and

FIG. 6 is a perspective view of the locking element.

### DETAILED DESCRIPTION OF THE INVENTION

In the description of the figures below, terms such as above, below, left, right, front, back etc., refer exclusively to the exemplary representation and position of the flexible line, the flashlight and the like selected in the respective figures. The terms are not to be understood in a restricting manner, that is to say that it is possible to modify these references by means of different operating positions or the mirror-inverted design or the like.

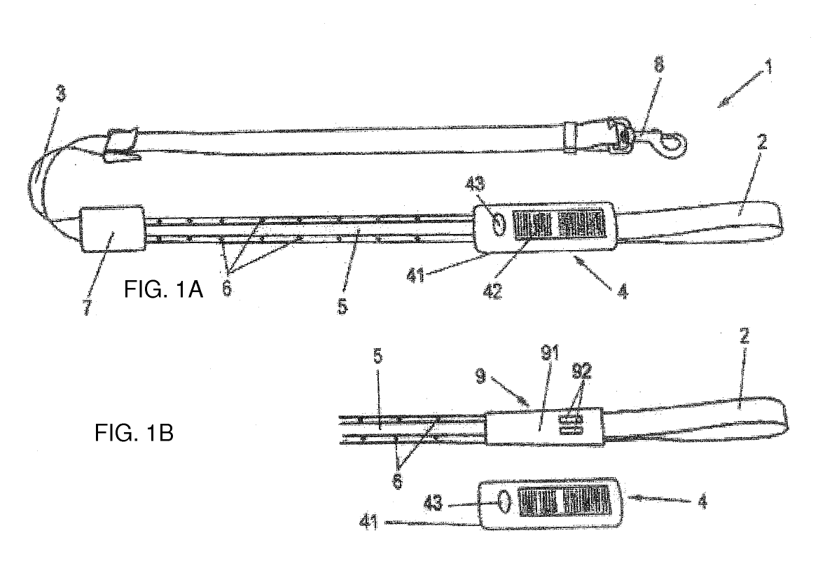

Referring now to the figures of the drawing in detail and first, particularly, to FIG. 1 thereof, there is shown a flexible line 1 which is implemented, in the exemplary embodiment, as a strap or leash of an animal guide device. It is also conceivable to use the flexible line 1 on a purse, for example as a shoulder strap or a handle, or on an item of clothing or the like.

The flexible line 1 shown in FIG. 1 has a first end which is formed into a loop 2, to serve as a hand loop. A snap-type connector 8, which can be snap-connected into the collar or harness of a dog or another domestic animal, is arranged, for example, at the other end of the flexible line 1.

The flexible line 1 consists primarly of a strap or a leash, in particular woven from natural fibers or plastics fibers, or even a leather belt.

At least one region 5 which reflects light is preferably provided on the line 1 such that when light is shone on the line, the line reflects back or scatters the light and thus is easily identified even in the dark.

In addition, at least one electric consumer 6 is fastened on the line. The electric consumer is preferably realized as a signal generator, in particular as a luminant or ultrasonic generator. It is also conceivable to design the electric consumer as a charging station or current generator for a cell phone or a music player such as a radio or an MP3 player or the like.

The at least one electric consumer 6 is connected by means of electric cabling to a flashlight holder 9 for the releasable holding of a flashlight 4 with an integrated voltage source. The flashlight holder 9, in this case, has electric contacts 92 which are couplable to the voltage source of the flashlight 4.

In addition, as claimed in a preferred design variant, a further energy storage means 7 is connected on the line 1, the further energy storage means being fastened on the line 1, the energy storage means 7 being connected to the at least one electric consumer 6. By means of the further energy storage means 7, for example in the form of a rechargeable battery, it is possible for the energy storage means 7 to be charged at the voltage source of the flashlight 4 without the flashlight inserted into the flashlight holder 9, which means that even when the flashlight 4 is not inserted into the flashlight holder 9, it is possible for the electric consumer 6 to operate.

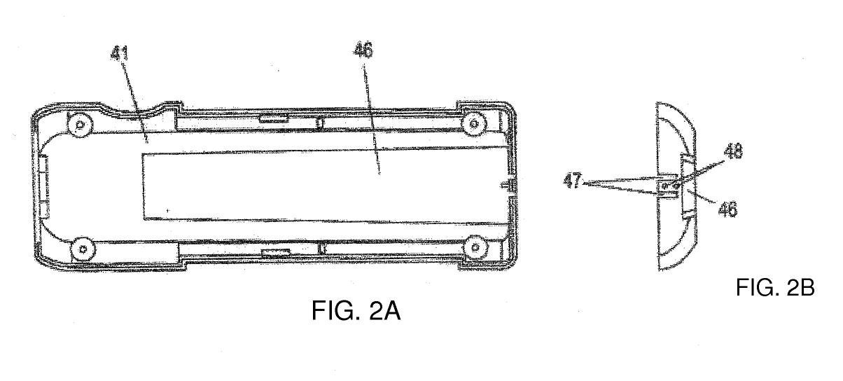

The fastening of the flashlight 4 on the flexible line 1 is effected preferably by means of a receiving web 91 which is provided on the flashlight holder 9 and can be slid in a groove 46 on the housing 41 of the flashlight as can be seen in FIGS. 2a) to b). In a preferred manner, in this case, the receiving web 91 is formed in a conical manner such that the flashlight 4 can always only be slid in one direction onto the flashlight holder 9. This ensures that the electrical contacts 92 of the flashlight holder 9 are always contacted by the correspondingly poled contacts of the flashlight 4, as is necessary in particular for charging energy storage means 7 which are realized as rechargeable batteries which are operated with direct current.

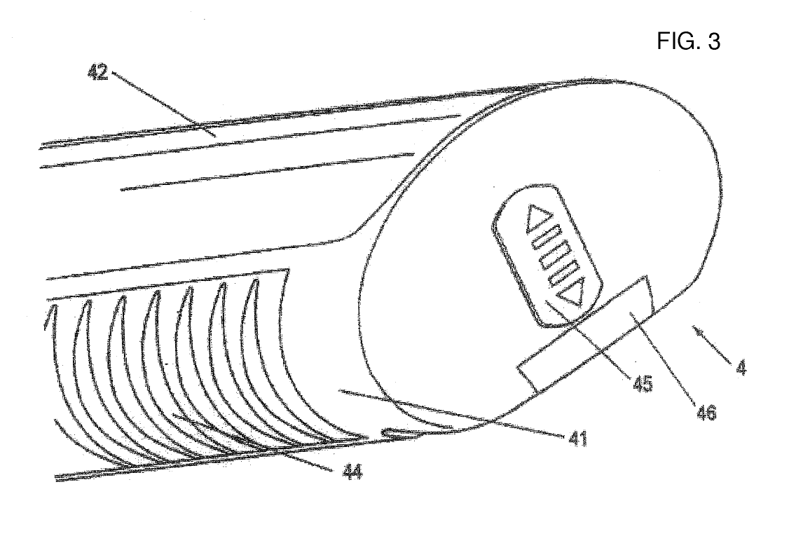

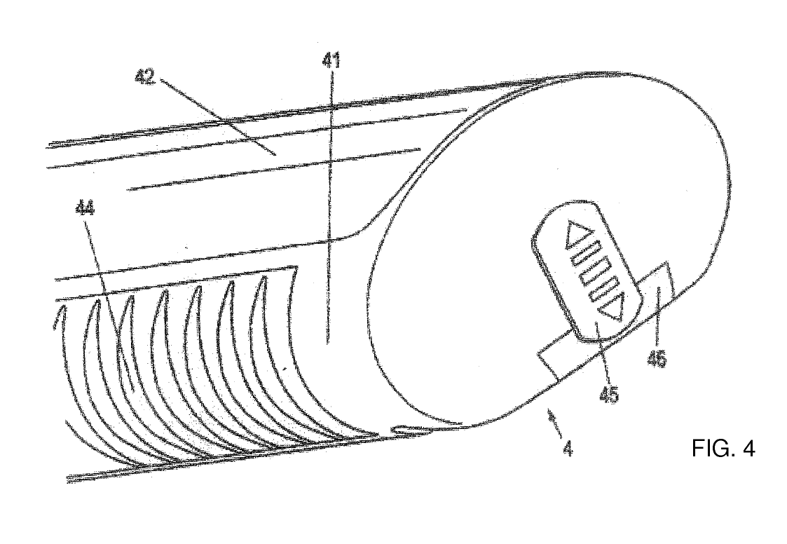

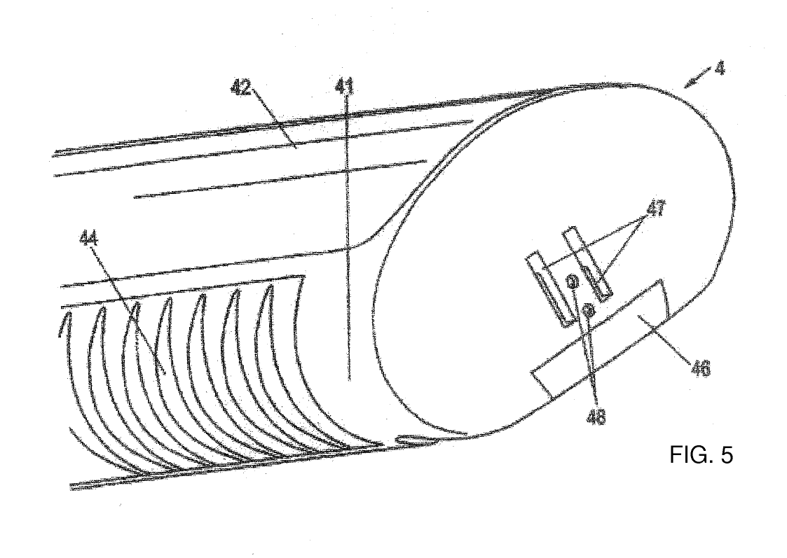

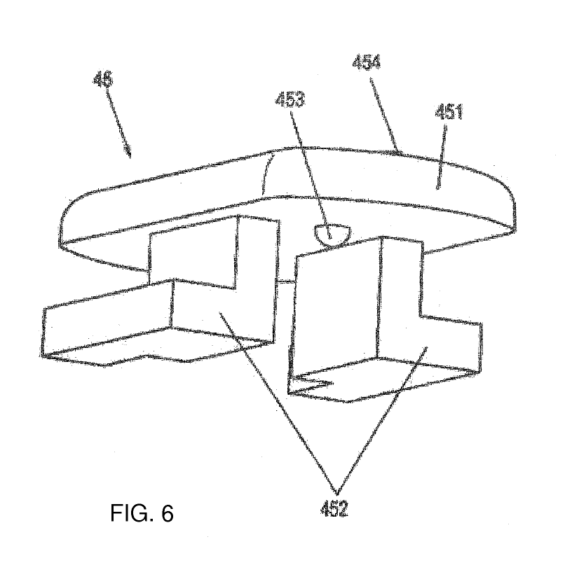

As is shown in FIGS. 3 to 6, the flashlight 4 has on an end face in which the undercut groove 46 terminates at a locking element 45. The latter is displaceable transversely with respect to the sliding-on direction of the flashlight holder 9 and, in a closed position (cf. FIG. 4), fixes the receiving web 91 in the groove 46. As a result, the flashlight 4 is prevented in an effective manner from being unintentionally released from the flashlight holder 9. The locking element 45, in this case, as can be seen in FIG. 6, is realized as a displacement element with webs 454, which project slightly out of the surface to facilitate handling the displacement element and project from a plate 451. Supports or displacement elements 452, which are admitted into elongated holes 47 in the housing 41 of the flashlight, protrude on the side of the plate 451 remote from the webs 454. In addition, a hemispherical locking element 453 is preferably provided on the underside of the plate 451, the locking element being lockable between two locking openings 48 provided in the end face of the housing 41 of the flashlight and by way of which the locking element 45 is slidable back and forth between two predefined positions.

In a preferred manner, the flashlight 4 itself has a solar module 41 on the opposite upper surface on the flashlight holder 9, by way of which solar module the voltage source, which is integrated in the flashlight 4 and in a preferred manner is realized as a rechargeable battery, can be charged and, in this way, an environmentally-friendly disposal of both the flashlight 4 itself and of the electric consumer 6 which is arranged on the flexible line 1 is ensured.

The following is a list of reference numerals, as used in the description above. The list may aid the reader in a ready understanding of the specification:
1 Flexible line
2 Loop
4 Flashlight
5 Region reflecting light
6 Electric consumer
7 Energy storage means
8 Snap-type connector
9 Flashlight holder
41 Housing
45 Displaceable locking element
46 Groove
47 Elongated holes
48 Snap-in opening
91 Receiving web
92 Electric contacts
451 Plate
452 Displacement element
453 Locking element
454 Projecting webs

1. A flexible line assembly, comprising:
a flexible line;
at least one electric consumer disposed on or integrated in said flexible line;
a flashlight holder for releasably mounting a flashlight to said line, said flashlight holder carrying electrical contacts connected to said at least one electric consumer; and
a flashlight having an integrated voltage source, said flashlight and said flashlight holder being configured such that said at least one electric consumer is couplable to said voltage source of said flashlight when said flashlight is mounted to said flashlight holder.

2. The line assembly according to claim 1, wherein said electric consumer is a signal generator.

3. The line assembly according to claim 2, wherein said electric consumer is a luminant or an ultrasonic generator.

4. The line assembly according to claim 1, wherein said flexible line has at least one reflective region that reflects visible light.

5. The line assembly according to claim 1, wherein said electric contacts of said flashlight holder are connected to an energy storage device that is fastened on said line, and wherein said energy storage device is connected to said at least one electric consumer.

6. The line assembly according to claim 1, wherein said voltage source of said flashlight is connected to a solar module mounted on a surface of said flashlight.

7. The line assembly according to claim 1, wherein said flashlight holder has a receiving web to be slid into a groove formed in a housing of said flashlight.

8. The line assembly according to claim 7, which comprises a locking element disposed on an end face of said flashlight at which said groove terminates, said locking element being displaceable transversely with respect to a sliding-on direction of said flashlight holder and, in a closed position, fixing said receiving web in said groove.

9. The line assembly according to claim 1, wherein said electric consumer is a charging station.

10. The line assembly according to claim 1, configured as a strap or a leash of an animal guide device, a strap of a purse, or a strap of an item of clothing.
